(19) United States
(12) Patent Application Publication
(10) Pub. No.: US 2015/0110934 A1
(43) Pub. Date: Apr. 23, 2015

(54) DISPERSAL UNITS

(71) Applicant: AG THAMES HOLDINGS LTD, Crayford, Kent (GB)

(72) Inventor: Sarah Taylor, Crayford (GB)

(73) Assignee: AG THAMES HOLDINGS LTD, Crayford, Kent (GB)

(21) Appl. No.: 14/382,475

(22) PCT Filed: Mar. 4, 2013
(86) PCT No.: PCT/GB2013/050532

§ 371 Date: Sep. 2, 2014

(30) Foreign Application Priority Data
Mar. 2, 2012 (GB) 1203784.2
Jan. 18, 2013 (GB) 1300954.3

(51) Int. Cl. A23B 7/152; A23B 7/158

(52) U.S. Cl. CPC A23B 7/152; A23B 7/158; A23V 2002/00
USPC 426/320; 99/534

(57) ABSTRACT

A dispersal unit for use in treating perishable goods in a storage volume to control microbial growth, the dispersal unit comprising: a housing; an airflow passage in the housing; an impeller for driving a flow of air through the airflow passage; a support for supporting at least one replaceable cartridge in communication with the airflow passage; and a vapouriser for promoting vapourisation of a volatile antimicrobial active material in a cartridge supported by the support to release an antimicrobial vapour from the cartridge into the airflow passage to be entrained in the flow of air and expelled from the airflow passage into the storage volume. The support is a base wall of a shallow vapourisation chamber that incorporates the airflow passage between the base wall and an upper wall spaced from the base wall and has openings between the base wall and the upper wall defining an inlet and an out let of the vapourisation chamber The height of the vapourisation chamber between the base wall and the upper wall is less than 40% of a width or length of the base wall.

### FIELD OF THE INVENTION

The present invention relates to a dispersal unit, method and cartridge for guarding against the onset of rotting or microbial growth on perishable goods disposed in a storage volume during growth, transit, storage and transfer to the shelf.

### BACKGROUND TO THE INVENTION

Perishable goods such as fruits, vegetables, flowers, grains, spices, coffee and cocoa beans are known to be susceptible to rotting and microbial growth (e.g. growth of bacteria, fungal pathogens and mould). This spoils the perishable goods leading to losses and wastage. Sales of soft fruits in the UK alone are presently valued at around £760 million; hence, spoilage of even a small percentage of this fruit results in significant financial losses for growers, packers, wholesalers, transporters and retailers.

For example, along a typical supply chain, around 1.5% of fruit is wasted at the farm due to spoilage (a loss of around £11.4 million for farmers), around 3.2% is wasted at supermarkets or other shops (a loss of around £24.32 million for retailers and wholesalers), and approximately 20% is wasted in the home after purchase (a loss of around £150 million for end customers). An additional 0.5% is returned by customers who are dissatisfied with the life of the product, at a loss of around £3.8 million, usually passed on to the supplier. The total wastage is therefore estimated at around 25%, or around £190 million per year. Thus, even a small reduction in the percentage of soft fruit that succumbs to spoilage will have a significant real-term impact on losses due to wastage.

The issue of microbial growth is particularly problematic during post-harvest storage and transportation of perishable goods. Typically, perishable goods such as fruits are packed, either loosely or in packaging such as punnets, into storage containers such as cardboard cartons or plastic trays, which are stacked up on wooden pallets for storage or transportation. This means that the perishable goods are closely packed into small storage spaces. The majority of microbial growth in perishable goods results from infections originating from spores in the air and on the surface of the goods. The close packing conditions of the perishable goods facilitates cross-contamination of microbes, and increases spoilage of fruit.

This storage and cross-contamination of perishable goods occurs at all stages of the supply chain, from field to shelf. For example, perishable goods may be stored in this way immediately after harvest when stored by growers, during transport to and from packers, during storage with wholesalers or supermarkets, and during shipping between and within countries.

Pre-harvest crops are also prone to microbial growth. This can be particularly problematic if the crops are grown in close proximity and within an enclosed space such as a greenhouse or a growing tunnel or tube. Pre-harvest treatments for controlling microbes are common, and frequently involve spraying fungicides onto pre-harvest crops to control microbes. However, such treatments are generally unsuitable for use on post-harvest perishable goods, as they may leave residues that are unsuitable for human consumption. Pre-harvest treatments provide control of microbes in pre-harvest goods, but provide no longer-term control of microbes that originate post-harvest.

Hence, there is a need for a treatment that is capable of controlling microbial growth in both pre-harvest and post-harvest perishable goods. Despite this need, however, there has been little success in developing methods for controlling microbial growth, particularly in post-harvest perishable goods.

For many years, attempts have been made to control microbial growth by exploiting the antimicrobial properties of essential oils. To control the release of the essential oils, they may be adsorbed onto a microporous solid, such as a zeolite. To increase adsorption of the essential oil onto the zeolite, a solvent such as ethanol may be included. Efforts to date have focused primarily on incorporating essential oil/zeolite mixtures into packaging materials in order to produce what is known in the field as ‘active packaging’.

For example, in Japanese patent application JP 58-63348 to Shimizu, published in 1983, an essential oil is combined with a zeolite which is then kneaded into a plastic.

The plastic is formed into a sheet or film, and then sealed inside a package with food. In Japanese patent application JP 59-132876 to Akira, published in 1984, a mixture of ethyl alcohol and an essential oil is supported on a carrier, then coated onto a polyethylene film which is placed in a container together with food.

More recently, in PCT application WO 2008/149232 to Sabehat, published in 2008, a mixture of an essential oil, a solvent, and a micro-porous solid may be coated or printed onto a packaging film, provided in the mass of a substrate, or provided as granules to be packed in porous sachets for including in food packaging.

However, such ‘active packaging’ materials based on mixtures of essential oils and microporous solids have been found to be largely ineffective in preventing spoilage of perishable goods. A possible cause of this is the process of incorporating the mixtures into, or coating the mixtures onto, the packaging films, which may remove so much of the essential oil from the mixture that little antimicrobial material remains in the resulting active packaging. Little benefit is therefore provided by the active packaging, and it is negated by the higher cost of the active packaging materials when compared to standard packaging materials.

A scientific paper entitled “Active label-based packaging to extend the shelf-life of “Calanda” peach fruit: Changes in fruit quality and enzymatic activity” (P. Montero-Prado, A. Rodriguez-Lafuente and C. Nerin, Postharvest Biology and Technology, 60 (2011) 211-219), describes using an ‘active label’ on packaging, which is coated with cinnamon essential oil. No microporous solid is used in the coating material. Such label-based active packaging incorporating active labels has shown good results over a period of eight days on punnets of Calanda peaches. However, the active labels were not tested for periods of greater than eight days, and were not tested on any other perishable goods.

Even if effective in reducing microbial growth over short periods of time, active packaging is an inadequate solution to the problem of post-harvest microbial growth for several reasons. For example, the amount of essential oil that can be adsorbed onto a packaging film is limited, thereby limiting the period over which essential oils can be released to days, or even hours.

Furthermore, active packaging inherently requires packing the perishable goods into packages such as punnets. Supermarkets and other suppliers have, in recent years, been subject to criticism for the high levels of packaging that are used for fruits and vegetables, due to the high levels of wastage and large amount of energy required to produce and (where possible) recycle the packaging materials. Hence there is a trend towards reduction of the quantity of packaging, and an increase in loose fruit and vegetables that are not packaged into punnets or other packages. The use of active packaging materials is therefore in conflict with the desire to reduce volumes of packaging materials.

Perhaps the most significant disadvantage of active packaging materials is that they only provide antimicrobial protection for post-harvest perishable goods, and only once the fruit has been packaged, for example into individual punnets. In particular they provide no protection for pre-harvest perishable goods, or during storage or transportation prior to packaging, for example when the fruit is loose-packed in storage crates. Thus, even an effective active packaging material could not solve the problem of spoilage of post-harvest perishable goods throughout the entire ‘field to shelf’ supply chain.

Hence there has been a long-felt need to reduce rotting and microbial growth in perishable goods over extended periods of time and at all stages of the supply chain, which need has not yet been met despite many decades of research. Accordingly it is an object of the present invention to meet this need, and to mitigate or overcome the problems described above.

### Statements of the Invention

Against this background, the invention resides in a dispersal unit for use in treating perishable goods in a storage volume to control microbial growth. The dispersal unit comprises a housing, an airflow passage in the housing, an impeller for driving a flow of air through the airflow passage, a support for supporting at least one replaceable cartridge in communication with the airflow passage, and a vapouriser for promoting vapourisation of a volatile antimicrobial active material in a cartridge supported by the support to release an antimicrobial vapour from the cartridge into the airflow passage to be entrained in the flow of air and expelled from the airflow passage into the storage volume. The support is a base wall of a shallow vapourisation chamber that incorporates the airflow passage between the base wall and an upper wall spaced from the base wall and has openings between the base wall and the upper wall defining an inlet and an outlet of the vapourisation chamber. The height of the vapourisation chamber between the base wall and the upper wall is less than 40% of a width or length of the base wall.

The invention provides a dispersal unit by means of which a volatile antimicrobial active material can be efficiently vapourised and delivered to a storage volume. A required dosage or concentration of the antimicrobial vapour can be delivered for a dispersal period with low energy input. In the course of a treatment period, the antimicrobial vapour kills microbes on the surface of the perishable goods. The perishable goods are therefore substantially free of microbes when they are removed from the storage volume. Subsequent antimicrobial growth is therefore low, and the incidence of rotting of the perishable goods as reduced by treatment with the dispersal unit. The post-treatment life of the perishable goods is therefore increased, reducing wastage at later stages of a supply chain.

The low profile of the shallow vapourisation chamber means that the dispersal unit is compact, and can be arranged in a small space in a storage volume, so that the dispersal unit does not require space that would otherwise be occupied by stored perishable goods. The low profile also enables a large area of contact between the airflow in the airflow passage and the cartridge. In this way, the antimicrobial vapour can be efficiently entrained in the airflow, such that the power consumption of the dispersal unit is low.

Further o increase the efficiency of the dispersal unit, the support may be arranged to support a plurality of cartridges. Preferably, the support is elongate in an airflow direction through the unit, such that the cartridges may be disposed in succession in the airflow direction.

In preferred embodiments, the vapourisation chamber is elongate between an inlet at one end and an outlet at an opposite end. The vapourisation chamber may further comprise side walls between the base wall and the upper wall. For ease of construction, the upper wall is preferably a wall of the housing.

To facilitate use of the unit, and in particular removal and replacement of the cartridge, in preferred embodiments, the upper wall can be lifted away from the support to replace the cartridge.

The support may be a hotplate that serves as the vapouriser. The hotplate provides a flat surface that supports the cartridge, and can be heated so as to heat the cartridge and vapourise the volatile antimicrobial active material contained within it. The support may arranged to receive the cartridge, for example in a recess or a bay.

So that the dispersal unit can fit into the storage volume, the dispersal unit is preferably dimensioned so as to fit under or within a storage pallet. For example, the dispersal unit may have a height that is less than 40% of its width. In particularly preferred embodiments, the dispersal unit has a height less than 35% of its length.

The invention also encompasses the dispersal unit described above when fitted with at least one cartridge between the support and the upper wall of the vapourisation chamber. In preferred embodiments, when the cartridge is fitted, the airflow passage is between the cartridge and the upper wall of the vapourisation chamber.

Preferably, the cartridge defines a first major face with at least one opening communicating with the volatile antimicrobial active material and is supported in the unit with its first major face exposed to the airflow passage. In this way, the antimicrobial vapour can easily diffuse through the opening into the airflow passage to be entrained in the airflow.

The cartridge may also define a second major face and may be supported in the unit with its second major face lying against the support. In embodiments where the support is a hotplate, the hotplate may heat the second major face of the cartridge so as to vapourise the volatile antimicrobial active material.

So that the space required by the cartridge is small in relation to the surface area of active material exposed to the airflow, the cartridge preferably has a thickness less than 20% of its length or width.

From a further aspect, the invention resides in a corresponding method of treating perishable goods to control microbial growth. The method comprises: placing a dispersal unit into a storage volume, the dispersal unit containing a volatile antimicrobial active material; vapourising the antimicrobial active material in the dispersal unit to produce an antimicrobial vapour; providing a first airflow in the dispersal unit to expel the antimicrobial vapour from the dispersal unit; and dispersing the antimicrobial vapour around perishable goods in the storage volume by means of a second airflow in the storage volume.

By means of the method, a volatile antimicrobial active material can be vapourised and expelled from the dispersal unit into a storage volume by a first airflow in the dispersal unit. Advantageously, the first airflow need be sufficient only to expel the vapour from the unit, and hence the airflow may be at relatively low flow rate, and may involve a relatively small volume of air. The first airflow therefore requires relatively little power. A second airflow provided in the storage volume is then used to disperse the antimicrobial vapour around the perishable goods. The first and second airflows in the dispersal unit and the storage volume respectively therefore act in synergy to disperse the antimicrobial vapour around the perishable goods within the storage volume while drawing only a small amount of power.

In using the method to treat perishable goods, the antimicrobial vapour kills microbes on the surface of the perishable goods. The perishable goods are therefore substantially free of microbes when they are removed from the storage volume. Subsequent antimicrobial growth is therefore low, and the incidence of rotting of the perishable goods as reduced by treatment with the dispersal unit. The post-treatment life of the perishable goods is therefore increased, reducing wastage at later stages of a supply chain.

Preferably, the second airflow is provided separately from the dispersal unit. For example, the second air flow may be provided by a refrigeration system in the storage volume. In this way, the method can exploit an airflow that would already be present in the storage volume.

The method may further comprise entraining the expelled antimicrobial vapour in the second airflow, so as to facilitate dispersal. Further to increase efficiency of the method, the first airflow may be parallel to, and in the same direction as, the second airflow. Optionally, the first airflow may drive the second airflow.

In preferred embodiments, air is drawn into the dispersal unit from one side of the storage volume and expelled from the dispersal unit to an opposite side of the storage volume. In this way, a flow of air in the dispersal unit aids circulation of air around the storage volume.

Preferably, the perishable goods are arranged in the storage volume on at least one pallet, and the method comprises placing the dispersal unit under the pallet. In this way, the dispersal unit can be located under the pallet, in space that would otherwise be empty and unused. The dispersal unit therefore takes up no additional space in the storage volume, and no storage space is lost. Furthermore, in conventional refrigerated storage containers, the refrigeration unit's airflow (i.e. the second airflow) is directed along a base of the storage container, under the storage pallets. Thus, by placing the dispersal unit under a pallet in a refrigerated storage container, the dispersal unit is placed in the second airflow, to facilitate dispersal of the antimicrobial vapour.

Preferably, the method further comprises vapourising the antimicrobial active material by heating. In this way, a rate of vapourisation can be controlled by controlling the temperature to which the antimicrobial active material is heated.

The method may be carried out during a storage period. The storage period may be any storage period in a typical supply chain. For example the storage period may be between harvesting the perishable goods and packing the perishable goods, and may take place, for example, at a packhouse.

The method may optionally be carried out during transportation of the perishable goods. For example, the method may be carried out during export of the perishable goods, and the storage volume may be a shipping container. Alternatively, the method may be carried out during transportation of the perishable goods within one country, for example from a packhouse to a storage depot, or from a storage depot to a shop, and the storage volume may be the load space of a refrigerated truck.

From a further aspect, the invention resides in a cartridge for use with the dispersal unit described above, the cartridge comprising a volatile antimicrobial active material contained in a cover. The cover is impermeable apart from an evaporation path to allow vapour to exit the cartridge, and the evaporation path can be closed by a removable closure.

The invention provides a cartridge out of which antimicrobial vapour can easily diffuse via the evaporation path, but that can be handled easily and safely because of the impermeable nature of the cover.

Preferably, the cover is at least partially formed from an impermeable material, and the evaporation path is defined by at least one opening in the impermeable material that communicates with the volatile antimicrobial active material. In this way, vapour can exit the cartridge through the opening.

Preferably, the cover comprises a first major face that incorporates the opening. Optionally, to prevent inadvertent spillage of the antimicrobial active material during use, the opening is provided with a vapour-permeable membrane.

In preferred embodiments, the cover defines a second major face that is impermeable. In use, the second major face is arranged in contact with a support of the dispersal unit. The impermeable nature of the second major surface means that the antimicrobial active material in the cartridge does not contaminate the support.

So that the cartridge requires a small amount of space in the dispersal unit while maximising the surface area for vapourisation, the cartridge preferably has a thickness less than 20% of its length or width. More preferably, the cartridge has a thickness less than 10% of its length or width.

To facilitate vapourisation of the antimicrobial active material, the cover may be formed at least partially from a heat-conducting material. The heat-conducting material may be, for example a metallic foil, such as aluminium.

It will be appreciated that preferred and/or optional features of the first and/or second aspect of the invention may be incorporated alone or in appropriate combination in other aspects of the invention also.

### BRIEF DESCRIPTION OF THE DRAWINGS

In order that the invention may be more readily understood, reference will now be made, by way of example only, to the accompanying drawings, in which:

FIG. 1 is a perspective view from the front, one side and above of a system of one embodiment of the present invention in conjunction with, and prior to insertion under, a typical storage pallet used in the storage or transportation of perishable goods, showing two alternative insertion positions;

FIG. 2 is a perspective view from the front, side and above of the system of FIG. 1;

FIG. 3 is a perspective view from the rear, side and below of the system of FIG. 1;

FIG. 4 is a perspective view from the rear, side and above of the system of FIG. 1, having a chassis which is transparent for the purpose of greater understanding of the invention;

FIG. 5 is an exploded perspective view from the front, side and above of the system of FIG. 1;

FIG. 6 is a perspective view from the front, side and above of a cartridge for use with the system of FIG. 1;

FIG. 7 is a longitudinal cross section of the cartridge of FIG. 6;

FIG. 8 is a transverse cross section of the cartridge of FIG. 6;

FIG. 9 is a perspective view of a chassis of a dispersal unit of the system according to an alternative embodiment of the invention, and a cartridge for use with that dispersal unit;

FIG. 10 is a flow chart illustrating the stages in a typical field-to-shelf supply chain for perishable goods, such as soft fruit;

FIGS. 11a and 11b show respectively comparative samples of untreated strawberries and strawberries treated according to the invention, each sample having been stored under shelf conditions for five days following treatment;

FIG. 12 is a graph illustrating the effect of hot plate temperature on the release of antimicrobial active material; and

FIGS. 13a, 13b and 13c are graphs illustrating the effect of solvent type and cartridge type on the release of antimicrobial active material.

In the drawings, like reference characters are used to designate the same or similar parts.

### DETAILED DESCRIPTION OF EMBODIMENTS OF THE INVENTION

The system and method now described are for the fumigation or treatment of perishable goods during growth, storage or transportation within a storage volume, based on the controlled vapourisation and dispersal of a volatile antimicrobial ‘active material’ within the storage volume.

The storage volume may be, for example, an enclosed growing area such as a greenhouse or like structure such as a tent, a ground engaging growing tunnel or tube, or an area covered by plastic mulching. The storage volume may also be a storage or transportation area, such as a room that is fixed within a building or complex, or an area within a shipping container, a truck, or a trailer. The storage volume may be air-tight, but this need not be the case. For example, the enclosure may be partially open, such as in a growing tunnel, but may be sufficiently enclosed that a rate of dispersal of the antimicrobial active material within the enclosure can be at least equal to a rate of loss of the antimicrobial active material from the enclosure. In this specification the storage volume is exemplified as a storage area for storage of post-harvest perishable goods.

In such storage areas, perishable goods are typically stored in crates or cardboard cartons/trays that are stacked onto storage ‘pallets’, which are usually of wood. These palletised stacks are packed closely into a container for storage or transport, henceforth referred to as a storage container. The ambient temperature and humidity of the storage container are controlled, with the aim of reducing spoilage of the perishable goods. Typically, the temperature of the storage containers is kept between 2° C. and 15° C., and the humidity is kept between 80% and 95%. The system and method now described are suitable for use in any storage area, although they are particularly suitable for use at temperatures of between 2° C. and 10° C. and humidity between 5% and 95%.

In this specification the term “perishable goods” refers to any goods that are susceptible to microbial growth. For example, it may include fruits, vegetables, legumes, herbs, or flowers, and may also include so-called ‘durable goods’ such as grains, spices, seeds and beans. In the embodiments described, with reference to the drawings, the perishable goods are exemplified as fruit.

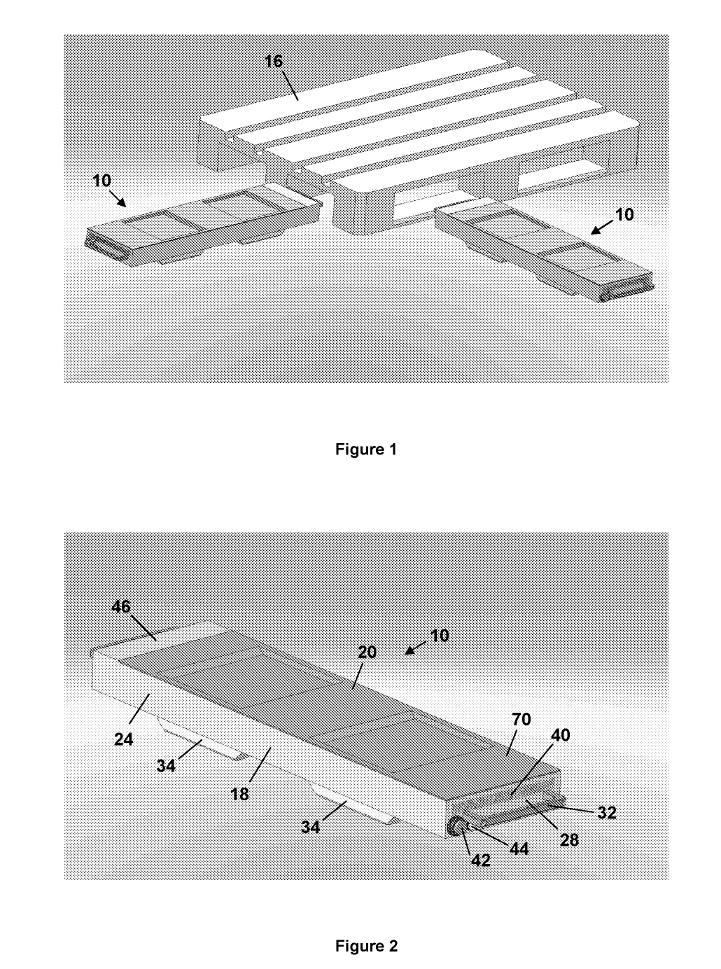

Referring to FIGS. 1 to 5 of the drawings, the system for guarding against the onset of rotting or microbial growth in perishable goods includes a dispersal unit 10, into which may be inserted one or more disposable receptacles, constituted by cartridges 12, containing a formulation 14 (FIG. 8) that includes a volatile antimicrobial active material. As best shown in FIG. 1, during transportation or storage of perishable goods, the dispersal unit 10 is placed inside the storage container (not shown), under or within a storage pallet 16.

When activated, the dispersal unit 10 increases a rate of vapourisation of the antimicrobial active material from the formulation 14, thereby producing an antimicrobial vapour. The dispersal unit 10 also includes an airflow means or impeller in the form of a fan 54, operative to provide a flow of air to move the antimicrobial vapour out of the dispersal unit 10 and into the storage area, so that the vapour is dispersed into the air surrounding the perishable goods, reducing microbial growth.

Referring to FIGS. 1 to 4, the dispersal unit 10 is of substantially cuboidal squat configuration, and is sized so as to fit under or within a storage pallet in either of the insertion positions shown in FIG. 1. For example, the dimensions of the dispersal unit may be approximately 1000×300×100 mm. In this way, the dispersal unit 10 may be arranged either under or within the wooden pallet without requiring additional space, which would reduce the quantity of fruit that could be stored in a given storage area.

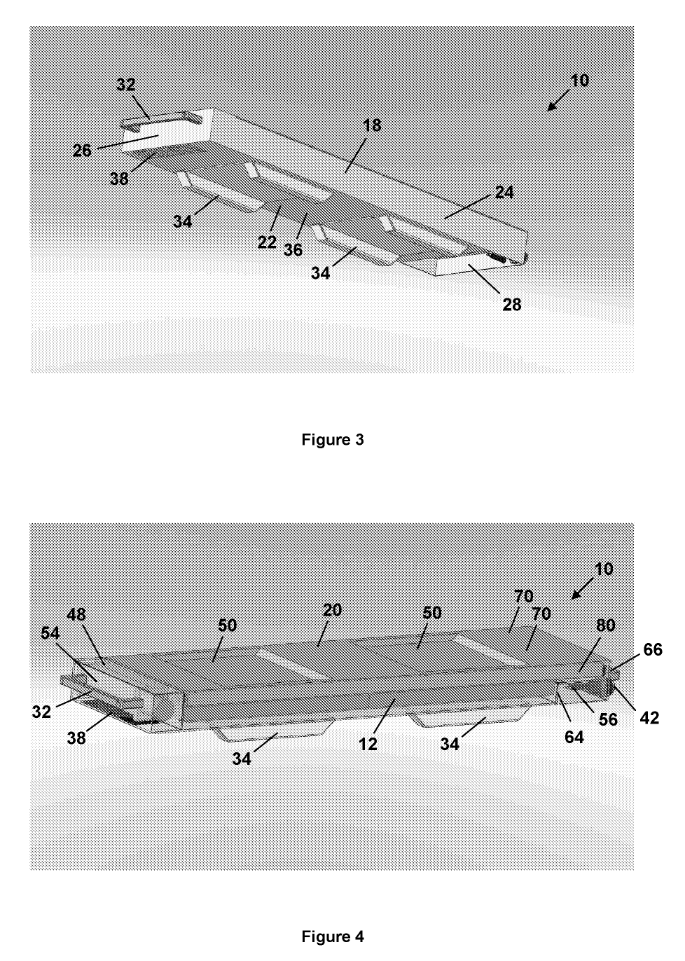

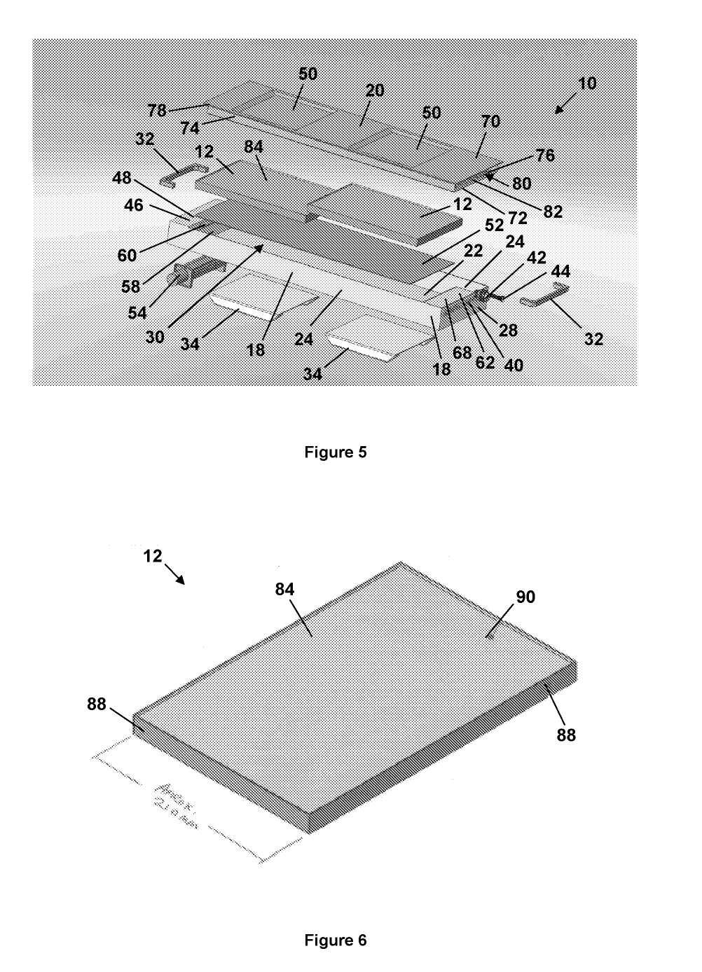

As seen more particularly in FIGS. 2 and 3, the dispersal unit 10 comprises a body 18 (exemplified here as a chassis) and a cover 20. The chassis 18 may be made from any suitable material, for example, stainless steel or plastics. The chassis 18 is shaped as a substantially flat rectangular tray, having a depth less than its width or length. A rectangular base 22 defines the width and length of the chassis 18. Longitudinal rectangular sidewalls 24 define its length and depth, and transverse rectangular sidewalls 26, 28 define its width and depth. Together, the base 22 and four sidewalls 24, 26, 28 define a tray having a tray recess, generally indicated at 30 (FIG. 5). The chassis 18 may typically have a length of approximately 900 mm, a width of approximately 300 mm and a depth of approximately 100 mm.

The first and second ends of the chassis 18 are provided with handles 32, so as to facilitate handling of the dispersal unit 10, and in particular insertion of the dispersal unit 10 under the storage pallets 16, and its subsequent removal. The base 22 of the chassis 18 is provided with runners 34 so as to reduce friction between the base 36 of the dispersal unit 10 and the floor of the storage container. This allows the dispersal unit 10 to be slid into and out of the pallets 16 easily. During storage of multiple dispersal units 10, the runners 34 also facilitate stacking of the dispersal units 10, as will be discussed later.

As best shown in FIG. 3, a vent 38 is provided in a first end of the base 22 of the chassis 18. This vent 38 allows movement of air into the dispersal unit 10 from the storage container. A vent 40 is also provided in the transverse sidewall 28 at the second end of the chassis 18, which allows movement of air out of the dispersal unit 10 into the storage container.

The chassis 18 is provided with an LED push switch 42, which activates the dispersal unit 10, and a timer 44, which a user can turn to set a desired dispersal time. Optionally, although not shown, the chassis 18 may be provided with additional components for selecting a specific dispersal programme, to be more fully described.

The cover 20 is arranged in the tray recess 30 of the chassis 18, and presents the majority of the upper surface of the dispersal unit 18; it is substantially rectangular in configuration, and is of substantially the same width as the chassis 18. The length of the cover 20 is shorter than the length of the chassis 18, so that a portion 46 of the chassis 18 extends beyond the cover 20. This portion 46 of the chassis 18 is the fan housing 48, to be discussed in more detail.

The upper surface of the cover 20 is provided with indentations 50 that are sized to receive the runners 34 of a second dispersal unit 10 when multiple dispersal units 10 are stacked on top of one another for storage purposes. This ensures that the dispersal units 10 are stacked evenly during storage, so that the stack is stable, and less prone to toppling.

FIGS. 4 and 5 show the inner structure of the dispersal unit 10, revealing that the dispersal unit 10 also comprises vapourising apparatus 52, exemplified as a heating means, and hereafter for convenience referred to as a heater, an airflow means 54 which is preferably a fan, a control apparatus indicated at 56 for controlling the heater 52 and the fan 54, and two removable cartridges 12.

The fan 54 is arranged within a fan housing 48 that is provided at a first end of the chassis 18, and adjacent to the first transverse sidewall 26. The fan housing 48 is substantially cuboidal, and may be integrated with the chassis 18. In this way, the first transverse sidewall 26 of the chassis 18 forms a first sidewall of the fan housing 48, and the base 22 and longitudinal sidewalls 24 of the chassis 18 form the base and sidewalls of the fan housing 48. The fan housing 48 is also provided with a second sidewall 58, parallel to its first sidewall.

When the fan 54 is in use the vent 38 allows the fan 54 to draw air from the outside of the dispersal unit 10 into the fan housing 48. A vent 60 is also provided in the second sidewall 58 of the fan housing 48, so as to allow the fan 54 to push air from the fan housing 48 into the tray recess 30.

A control means 56 housed in a control housing 62, is arranged at a second end of the chassis, adjacent to the second transverse sidewall 28. Like the fan housing 48, the control housing 62 is substantially cuboidal, and may be integrated with the chassis 18 such that part of the second transverse sidewall 28 of the chassis 18 forms a first sidewall of the control housing 62. The control housing 62 is also provided with a second sidewall 64 that is parallel to its first sidewall.

The height of the control housing 62 is less than the height of the chassis 18, so that a portion 66 of the second transverse sidewall 28 of the chassis 18 extends above the control housing 62. The vent 40 in the second transverse sidewall 28 of the chassis 18 is located in this portion 66 of the second transverse sidewall 28 of the chassis 18, to allow movement of air out of the tray region 30 of the chassis 18 and into the storage area. So as to allow easy access to the control means 56 for maintenance, the control housing 62 is provided without a base.

As best shown in FIGS. 4 and 5, the heater 52 is positioned in the base of the tray recess 30 and is shaped as a substantially flat plate. The heater may be, for example, an induction or resistive heater, and may be provided as a hot plate, formed from a metal or ceramic in contact with heating elements. The heater 52 is electrically connected to the control means 56 and may be powered by mains electricity, a generator, or by one or more batteries.

The heater may comprise one or more resistive heater mats bonded to the underside of a metal plate. Thermal insulation may be fitted below the heater mats to reduce heat losses. A temperature sensor may be fitted to the metal plate for control purposes. The top of the metal plate is preferably smooth for good heat transfer and ease of cleaning.

When the system is use, two or more cartridges 12 (to be further described) are disposed in contact with the heater 52 so as to allow direct heating of the cartridges 12. The cartridges 12 are constrained by the longitudinal sidewalls 24 of the chassis, the second sidewall 58 of the fan housing 48, and the second sidewall 64 of the control housing 62, so that no complex fitting mechanisms or catches are required.

The cover 20 rests upon the upper surfaces 84 of the cartridges 12, and upon an upper surface 68 of the control housing 62. FIG. 5 shows that the cover 20 is in the form of a rigid rectangular sleeve, defined by an upper (or first) surface 70, a base (or second surface) 72 and two parallel longitudinal sidewalls 74 that provide a space between the base 72 and the upper surface 70. The transverse ends 76 of the cover 20 are open.

The upper surface 70 of the cover 20 extends beyond the longitudinal sidewalls 74, so that the upper surface 70 of the cover 20 is both longer and wider than the base 72. In this way, the upper surface 70 defines an overhang region 78. When the cover 20 is assembled in the dispersal unit 10, this overhang region 78 rests upon the longitudinal sidewalls 24 of the chassis 18, the second transverse side wall 28 of the chassis 18, and the second sidewall 58 of the fan housing 48, so as to provide an air-tight seal around the chassis 18.

When the cover 20 is placed on top of the cartridges 12, the two open transverse ends 76 of the cover 20 align with the vents 40, 60 in the second transverse sidewall 58 of the fan housing 48, and the second transverse sidewall 28 of the chassis 18. In this way, the base 72, sidewalls 74 and upper surface 70 of the cover 20 define an airflow passage, generally indicated at 80. A first end of the air flow passage 80 is in communication with the fan housing 48, and a second end of the airflow passage 80 is in communication with the storage area, such that the fan 54 directs a flow of air through the airflow passage 80, out of the dispersal unit 10, and into the storage area.

At least a portion of the base 72 of the cover 20 is open, so as to allow direct contact between the airflow passage 80 and the cartridge 12. In one elegant embodiment of the invention, and as shown in FIG. 5, the base 72 may be provided with ventilation holes 82, or may be provided as a frame having a large aperture.

In an alternative embodiment of the invention, not shown, the base 72 of the cover 20 may be entirely open. In this embodiment, the upper surface 70 of the cover 20 is supported by the two sidewalls 74, and the airflow passage 80 is defined by the sidewalls 74, the upper surface 72 of the cover 20 and an upper surface 84 of the cartridge 12.

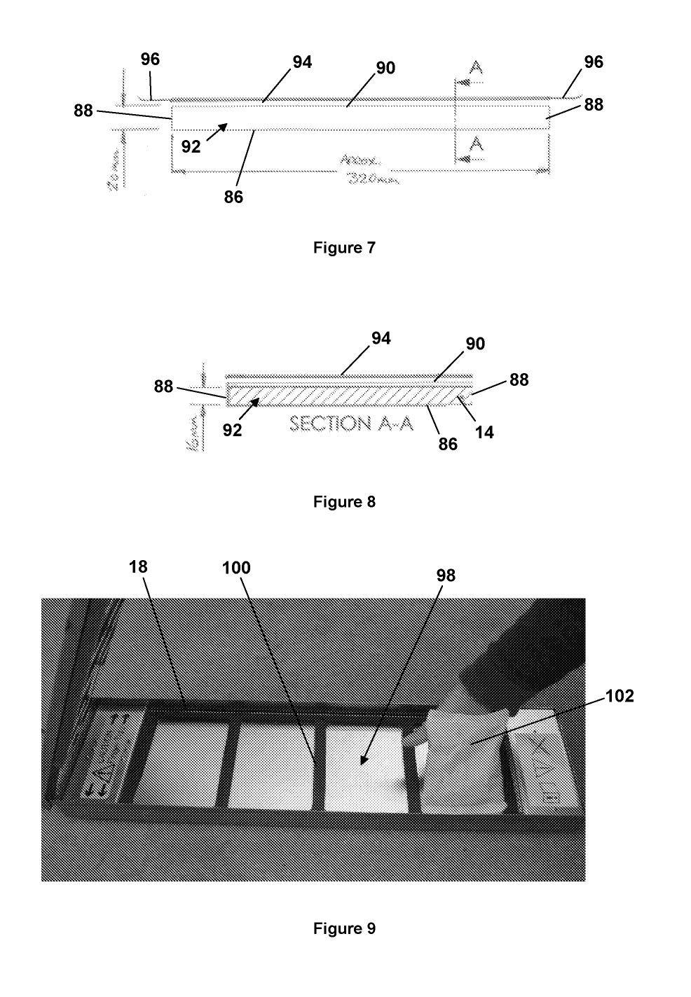

Referring particularly to the cartridge 12, and as best shown in FIGS. 6 to 8, the cartridge 12 is of substantially flat configuration, having a base 86 that defines its length and width, four sidewalls 88 that define its depth, and a liquid impermeable, vapour permeable covering membrane 90 (hereafter referred to for convenience as a membrane), that seals over the formulation 14 disposed in the cartridge. The base 86 and the four sidewalls 88 define a tray portion, generally indicated at 92. Preferably, the cartridge 12 is arranged in the shape of a cuboid having a depth substantially less than its length or width. For example, the cartridge 12 may have a depth of around 20 mm, a width of around 210 mm, and a length of around 310 mm.

The cartridge 12 containing the formulation 14 constrains it between the base 86, sidewalls 88, and membrane 90. In this way, the surface area of the formulation 14 is determined by the surface area of the base 86 of the cartridge 12. For example, if the cartridge 12 has a width of around 210 mm and a length of around 310 mm, the surface area of the base 86, and therefore of the formulation 14, is around 0.065 m². The depth of the formulation 14 is determined by the quantity of formulation 14 that is disposed within the cartridge 12. In the example given above, if the total volume of formulation 14 is 0.001 m³, the depth of the formulation 14 in the cartridge 12 will be approximately 16 mm. Preferably, the base 86 of the cartridge 12 has a large surface area, so as to ensure that the formulation 14 also has a large surface area to facilitate vapourisation of the antimicrobial active material from the formulation.

At least a portion of the base 86 of the cartridge 12 is formed from a material having a high thermal conductivity, such as aluminium, or any other suitable metal. In this way, heat may be conducted through the base 86 of the cartridge 12 to the formulation 14. Preferably, the base 86 is formed from pressed aluminium foil. The pressed aluminium foil is of high thermal conductivity allowing heating of the formulation with minimal heat loss, and also allowing a high degree of control of the temperature of the formulation. Optionally, the walls 88 of the cartridge 12 may be formed from the same materials as the base 86; preferably the base 86 and walls 88 are formed from a single piece of material.

Advantageously, the base 86 may be provided with formations (not shown), such as baffles, to hinder flow of the formulation 14 across the base 86 of the cartridge 12. In this way, if the cartridge 12 is disturbed during storage or use, the formations prevent the formulation 14 flowing to one side of the cartridge 12, thereby encouraging a uniform distribution of the formulation 14 within the cartridge 12, and facilitating careful control of the release rate of the antimicrobial active material.

The formulation 14 is retained within the tray portion 92 by the membrane 90, which is sealed to the tray portion 92 in an air-tight fashion. The membrane 90 forms at least a part of the upper surface 84 of the cartridge 12. It must prevent the formulation 14 escaping the cartridge 12, whilst allowing vapour of the antimicrobial active material to pass through it. The membrane 90 is therefore impermeable to the formulation 14, but at least a portion of it is permeable to the vapour of the antimicrobial active material. For example, the membrane 90 may be formed entirely or partially from polyethylene, which is impermeable to liquid but permeable to vapour, such as the vapour of antimicrobial active materials.

Prior to use of the cartridge 12, loss of any of the antimicrobial active material may be prevented by provision of a cover constituted by a lid 94, which is impermeable to the vapour of the antimicrobial active material, so that vapour cannot escape the cartridge prior to its use. The lid 94 covers the membrane 90 and is sealed in a leak-tight fashion either to the membrane 90 itself, or to the sidewalls 88 of the cartridge 12, so as to prevent any loss of vapour of the antimicrobial active material. A user may remove the lid 94 from the cartridge 12 by peeling the lid 94 as by tab member 96 from the cartridge 12. Once the lid 94 has been removed, the cartridge 12 has been ‘activated’, and is ready for insertion into the dispersal unit 10.

In an alternative embodiment of the invention, not shown, the receptacle is provided as a bag such as a sachet that is formed at least partially from a material that is impermeable to the formulation, but permeable to the antimicrobial vapour. For example, the sachet may be made from a natural fibrous material, or a man-made fibre such as polyethylene or nylon. In this way, the sachet is entirely or partially constructed from a membrane that is impermeable to the formulation, but permeable to the antimicrobial vapour.

In use, one or more sachets are placed directly on to the heater, so the heater can heat the sachet, thereby vapourising the antimicrobial active material. For storage purposes, each sachet is provided with a cover constituted by an outer bag that is impermeable to the antimicrobial vapour. The outer bag is sealed around the sachet in an air-tight fashion, so as to prevent loss of any of the antimicrobial active material. Prior to use, the user removes the sachet from the outer bag to ‘activate’ the sachet.

As mentioned previously and which will now be described more fully, the formulation 14 provides the antimicrobial vapour for dispersal within the storage area, and includes an antimicrobial active material, which is capable of vapourisation.

The antimicrobial active material may be any active material that produces a vapour capable of providing antimicrobial protection. For example, the antimicrobial active material may be an essential oil, a natural isolate (i.e. a component of an essential oil) or a nature-identical chemical (i.e. a synthetic chemical identical to the natural chemical). Essential oils, natural isolates and nature-identical chemicals are particularly advantageous, as many are known to be safe for contact with food. For example, many are categorised ‘generally recognised as safe’ (GRAS), which exempts them from the requirement of pre-market approval by the US Food and Drug Administration.

It is known that different essential oils, natural isolates and nature-identical chemicals can be particularly effective against different microbes. The antimicrobial active material may be selected, for example, to control a microbe that is particularly prevalent in the perishable goods that are to be treated. For example, in fruits such as strawberries Botrytis cinerea is the most prevalent microbe. The chemical thymol is particularly effective against Botrytis cinerea and may therefore be preferred for use in treatment of strawberries. To provide optimum protection against several microbes, more than one essential oil, natural isolate or nature-identical chemical may be used.

To ensure controlled release of the vapour throughout the duration of the storage period, the formulation 14 may further comprise a microporous solid, so that the antimicrobial active material is adsorbed onto the surfaces of the pores of the micropourous material. With the application of heat, the antimicrobial active material is gradually desorbed from the microporous solid and vapourised to form an antimicrobial vapour.

The microporous solid may be any inert microporous solid onto which the antimicrobial active material can be adsorbed. For example, the microporous solid may be zeolite, silica, alumina, clay or a fibrous material. Preferably, the microporous solid is a naturally occurring material and/or is approved for contact with food by the relevant regulatory authority.

In one embodiment, the microporous solid is provided as a granular product. In this way, the surface area of the microporous solid, from which the antimicrobial active material is adsorbed and desorbed, is maximised. This allows a large amount of the antimicrobial active material to be adsorbed onto the microporous solid, and facilitates desorption upon heating of the formulation 14.

In one particularly preferred embodiment, the microporous solid is a zeolite. Zeolites are naturally occurring aluminosilicate materials, having porous atomic structures that can accommodate, for example, molecules of an antimicrobial active material.

Ideally, and as is known, the formulation 14 also comprises a solvent, which may be any suitable solvent. The antimicrobial active material may be dissolved in the solvent to increase adsorption of the antimicrobial active material onto the surface of the pores of the microporous solid. The solvent should be approved for use in contact with food by the relevant regulatory authority, one such solvent being ethanol, which is known to have antimicrobial properties in itself. Although not yet approved by regulatory authorities, hexane is an alternative solvent that is also particularly advantageous, as it allows for particularly effective adsorption of the antimicrobial active material onto the microporous solid.

To make the formulation, the antimicrobial active material is dissolved or diluted in the solvent, for example a food-grade ethanol, to produce the required concentration. This solution of the antimicrobial active material and the solvent is gradually added to the microporous solid, for example by spraying, whilst stirring or mixing gently, in order to obtain a uniform loading of the solution on the microporous solid. The mixing procedure is conducted in an environment that minimises vapourisation of the active material. When the mixing is finished, the formulation is immediately packed into the receptacle, which is then placed in an outer packaging and sealed, for example by vacuum sealing.

The operation of the dispersal unit 10 shown in FIGS. 1 to 5, in combination with a cartridge 12 shown in FIGS. 4 to 8, will now be described.

A user selects two cartridges 12 and ‘activates’ them by removing their uppermost lids 94, so that the membrane 90 is exposed. The user places the two cartridges 12 into the dispersal unit 10, on top of the heater 52, and then places the cover 20 on top of the cartridges 12. This assembly of components does not require the use of tools.

The dispersal unit 10 is then inserted under or into a storage pallet 16 within a storage area. Once in position, the user activates the dispersal unit 10 by pressing the LED switch 42. Optionally, the user may select an appropriate programme, or may set a timer 44 to correspond to the duration of treatment required. The LED switch 42 activates the heater 52 and fan 54.

The heater 52 transfers heat to the base 86 of the tray portion 92 of the cartridge 12. When the base 86 is heated, heat is transferred by conduction to the formulation 14 inside the cartridge 12. Upon heating, the antimicrobial active material is desorbed from the microporous solid, and vapourised. Surprisingly, the inventor has found that only a slight increase in temperature is required to ensure an adequate rate of desorption and vapourisation.

As the antimicrobial active material is removed from the microporous solid, the liquid content of the formulation 14 is reduced. When all the antimicrobial active material has been used up, no liquid is left in the formulation 14. At this stage all that remains of the formulation 14 will be a dry powder of the microporous solid. This dry powder can be retained within the cartridge 12 to avoid contamination of the stored fruit, which allows for easy disposal of the cartridge 12, or of the formulation 14 in other available ways.

The fan 54 draws air out of the storage area and into the fan housing 48 through the vent 38 in the base of the chassis 18, and then pushes the air out of the fan housing 48 and into the airflow passage 80 through the vent 60 in the second sidewall 58 of the fan housing 48. This airflow is constrained by the airflow passage 80.

As the flow of air flows across the surface of the membrane 90 of the cartridge 12, and hence over the formulation 14, the vapour of the antimicrobial active material that has permeated through the membrane 90 mixes with the airflow by convection. Thus, when the flow of air passes out of the dispersal unit 10 and into the storage area, the vapour is similarly delivered into the storage area.

Additionally, the air moving across the surface of the membrane 90 creates a negative pressure that encourages further vapourisation of the antimicrobial active material, and increases diffusion of the vapour through the membrane 90 and into the airflow passage 80.

The flow of air produced by the dispersal unit is sufficient to expel the antimicrobial vapour into the storage area. A second airflow, such as that produced by the storage container's refrigeration unit (not shown), disperses the antimicrobial vapour within the storage area. This provides a uniform dispersal within the storage area around the perishable goods. Surprisingly, computer modelling has shown that, for a forty-foot sea container or a twenty-six-palette refrigerated truck trailer, the airflow produced by a typical refrigerated air system is sufficient to provide a uniform dispersal within a storage area in a period of around just 20 minutes.

At the end of the storage period, the timer 44 or pre-set programme may automatically deactivate the dispersal unit 10. Alternatively, the user may deactivate the dispersal unit 10 manually by pushing the LED switch 42. The user removes the cover 20 of the dispersal unit 10, then removes and disposes of the spent cartridges 12.

To store the dispersal unit 10, the user replaces the cover 20 so that multiple dispersal units 10 may be stacked, with the runners 34 on the base 36 of an upper dispersal unit 10 being received into the indentations 50 on the cover 20 of a lower dispersal unit 10. The dispersal unit 10 may then be reused as required with fresh cartridges 12.

Hence, in use, the dispersal unit 10 described above disperses a vapour of the antimicrobial active material into the storage area, and therefore into the air surrounding the stored fruit to provide antimicrobial protection throughout the duration of a storage period. The presence of the vapour guards against microbial growth, and reduces spoilage of the fruit.

The dispersal unit 10 made in accordance with the present invention relies on careful control of the dispersal rate of the antimicrobial active material. This is crucial in ensuring that the vapour of the antimicrobial active material is present in the air surrounding the stored fruit in the correct concentration throughout the duration of the storage period. Hence, it is crucial in successfully controlling microbial growth on the stored fruits.

For example, if the dispersal rate is too high, the concentration of the vapour in the storage container will be similarly high, and may have adverse effects on the fruit, such as ‘burning’ and the development of taints. A further affect will be that the antimicrobial active material will be used up too quickly, so that there is no antimicrobial active material available for a period of time towards the end of the storage period. Should this occur, there would be insufficient or sub-optimal antimicrobial protection.

Conversely, if the dispersal rate is too low, the concentration of the vapour in the storage area may also be too low, so that the system does not provide adequate antimicrobial protection, which leads to spoilage of the fruit.

In some storage situations it may be necessary to vary the dispersal rate over the course of the storage period. For example, a higher dispersal rate may be required initially, to ensure that the concentration of the vapour in the storage area is quickly brought up to the optimum level. The dispersal rate may then be lowered by the selected programme so that the concentration is maintained at the optimum level for the duration of the storage period.

Thus, careful control of the dispersal rate must be maintained throughout the storage period, and a delicate balance must be struck to ensure that optimum control of microbial growth is achieved.

In the system operated in accordance with the present invention, numerous factors control the dispersal rate of the vapour of the antimicrobial active material. The key factors, to be described below, are i) the surface area of the formulation 14, ii) the components of the formulation 14, and iii) the temperature of the formulation 14, and the airflow rate produced by the fan 54. These factors are brought together to work in synergy, so as to produce an optimum dispersal rate and therefore effective antimicrobial protection, whilst keeping energy and cost requirements to a minimum.

The first factor discussed above is the surface area of the formulation 14.

It should be appreciated that the antimicrobial active material is desorbed and vapourised primarily from the surface of the formulation 14. Hence, a large surface area will encourage vapourisation of the antimicrobial active material, reducing the amount of heat and airflow required, and therefore the energy required to operate the system. The size and shape of the cartridge 12, and in particular its width and length, may be tailored to fit individual storage or transportation needs. For example, cartridges 12 having smaller surface areas may be provided if slower release of the antimicrobial active materials is required. For high dosages of the antimicrobial active material, deeper cartridges 12 may be provided, allowing greater volumes of active material.

Turning now to the second factor, the dispersal rate will be affected by the components of the formulation 14. As previously discussed, the formulation 14 comprises an antimicrobial active material, and may optionally comprise a solvent and/or a microporous solid. The nature of each of these components will affect the dispersal rate of the antimicrobial active material. For example, different antimicrobial active materials will vapourise at different rates, resulting in different dispersal rates. Different solvents will also result in different rates of desorption, affecting the dispersal rate.

Most significantly, the rate of desorption of the antimicrobial active material will vary greatly amongst different microporous materials. For example, the properties of zeolites vary between members of the zeolite family. Pore size ranges from around 1 to 20 Å, and more antimicrobial active material will be adsorbed onto a zeolite with a larger pore size. Additionally, zeolites may be hydrophilic (e.g. X-zeolites, which have a silica:alumina ratio of between 2:1 and 3:1) or hydrophobic (e.g. Y-zeolites, which have a silica:alumina ratio of over 3:1), which will affect the adsorption and desorption of the antimicrobial active material. In a hydrophobic zeolite, the antimicrobial active material will be more strongly bound to the zeolite, and will therefore be released less easily and more slowly. Conversely, in a hydrophilic zeolite, the antimicrobial active material will be less strongly bound to the zeolite, and will therefore be released more easily and more quickly.

The properties of the microporous solid can therefore be optimised for the desired storage period and dosage of antimicrobial active material, particularly in the case of zeolites. For example, a hydrophilic zeolite may be more appropriate for shorter storage times, as the antimicrobial active material will be released more quickly. A zeolite with large pores may be more appropriate for situations requiring high dosages of the antimicrobial active material, as more of the antimicrobial active material can be adsorbed onto the zeolite.

If particularly high dispersal rates are required, the microporous material may be omitted from the formulation 14. In the absence of a microporous material to control desorption and vapourisation, the antimicrobial active material will be released very quickly over a relatively short period of time, even without the application of heat or a flow of air. Thus, a formulation 14 that does not include a microporous material would be suitable for use over short storage periods. For example, a formulation 14 not including a microporous solid would be particularly suitable for use in treating or fumigating an empty storage container to remove microbial spores from the storage area prior to use, since such a treatment would be best carried out over a short period of time and at a high dosage rate.

Turning finally to the third factor, the dispersal rate will also be affected by the temperature of the formulation 14 (and hence the temperature of the heater 52), and the airflow rate provided by the fan 54. For example, a higher temperature of the formulation 14 will result in a faster rate of desorption and vaporisation of the antimicrobial active material, and hence a higher dispersal rate.

It should be appreciated that the antimicrobial active material would release vapour even without applying heat or airflow to the cartridge 12. However, the dispersal rate in this case may be too slow to be effective. The low temperatures that are typically used for storage of perishable goods would result in a very low rate of desorption and vapourisation of the antimicrobial active material, and the absence of an airflow would mean that the vapour would move from the dispersal unit 10 into the storage area only by the very slow process of diffusion. The concentration of the vapour of the antimicrobial active material in the air surrounding the fruit would therefore be too low to provide effective antimicrobial protection. Thus, heat and airflow are vital in providing a system that produces a sufficiently high rate of dispersal of the antimicrobial active material.

The surface area and composition of the formulation 14 are determined during making of the formulation 14 and fabrication of the cartridge 12, and are therefore fixed for a given cartridge 12. The correct cartridge should therefore be selected for the particular storage situation. For example, cartridges of particular size or containing a particular antimicrobial active material will be best suited for a particular storage period, or for particular perishable goods.

Once the cartridge has been selected, the temperature of the formulation 14 (determined by the temperature of the heater 52) and the rate of airflow within the dispersal unit 10 can also be used to control the dispersal rate.

The optimum temperature and airflow rate must therefore be determined and then applied for different storage situations. As previously described, the optimum temperature and airflow rate may vary at different stages of the storage period. During use of the dispersal unit 10, the heat provided by the heater 52 and the airflow provided by the fan 54 must therefore be carefully monitored and controlled. This role is performed by the control means 56.

As previously discussed, both the fan 54 and the heater 52 are connected to the control means 56, which controls the temperature of the heater and the airflow rate produced by the fan. For example, the control means 56 can increase or decrease the flow of air produced by the fan 54 as required, and monitors and controls the temperature of the heater 52 by means of a temperature sensor. In this way the control means 56 can control the dispersal rate of the antimicrobial active material, to ensure optimum antimicrobial protection.

The control means 56 may be programmable to provide different temperatures and/or a different rate of airflow at different points during a storage period. For example, when the dispersal unit 10 is initially activated at the start of a storage period the temperature and air-flow rate may be set relatively high. This would encourage faster vapourisation and dispersal of the antimicrobial active material so that a sufficiently high concentration of the vapour could be reached quickly in the storage area. The control means 56 may also be capable of implementing different programmes for different storage situations. For example, the control means 56 may contain different programmes for short and long storage periods and/or high and low dosage requirements, and may include a selection means for implementing these different programmes.

Ideally, the LED switch 42 and the timer 44 are the only electrical components of the control means 56 that can be activated by the user. The control means 56 is pre-programmed and is not accessible to the user without using tools to deconstruct the dispersal unit. At the start of the storage period, the switch 42 is activated and the timer 44 may be set, whereupon the pre-programmed control means 56 controls the airflow rate and the temperature of the heater 52. In this way, a user cannot change the airflow rate and/or temperature of the heater 52 during or prior to operation of the dispersal unit 10, thereby increasing or decreasing the dispersal rate, and inadvertently preventing the system from providing optimal dispersal of the antimicrobial active material.

In particularly preferred embodiments of the invention, such as the embodiment illustrated in FIG. 9, the chassis 18 of the dispersal unit 10 is divided into a plurality of bays 98, which are separated by dividing walls 100. In the example illustrated, the chassis 18 is divided into four bays 98, each being approximately 20 cm long and 13 cm wide, and having a depth of approximately 1 cm.

For use of the system, four cartridges 12 are provided. In this embodiment, the cartridges 12 are provided in sachet form. Each cartridge 12 comprises a rectangular sachet having walls 102 made from a vapour-permeable heatsealable tissue. The heatsealable tissue 102 is made from a blend of thermoplastic fibres, abaca and cellulosic fibres that are vapour-permeable. Each sachet 12 is of a size and shape that is substantially the same as the size and shape of the bays 98. For use with the example illustrated, each sachet 12 is approximately 18 cm long and 13 cm wide, and, when arranged in the dispersal unit, has a depth of approximately 1 cm. Each sachet 12 contains approximately 250 g of the formulation 14, the formulation 14 comprising an antimicrobial active material, a solvent and a microporous solid, as previously described.

In use, the walls 102 of the sachet 12 prevent the microporous solid from leaking out of the sachet 12. The fibrous walls 102 absorb some of the antimicrobial active material, such that the walls 102 may also act as a microporous solid that supports some of the antimicrobial active material. Antimicrobial vapour is therefore able to pass through the walls 102, but the formulation 14 is prevented from leaking out of the sachet 12.

In this way, each sachet 12 has a surface area of approximately 0.0234 m², and a volume of approximately 0.000234 m³. The total surface area of the four cartridges 12 combined is therefore approximately 0.0946 m², and their total volume is approximately 0.000946 m³. In total, the four cartridges 12 hold approximately 1 kg of the formulation 14.

When the system 10 is in use, the heater 52 is heated to a temperature of approximately 40° C. to effect desorption and vapourisation of antimicrobial active material. Specifically, the heater 52 is maintained at a temperature between 39° C. and 41° C. The inventors have found that temperatures less than approximately 40° C. lead to a dispersal rate that is too low, while temperatures greater than approximately 40° C. lead to a dispersal rate that is too high, and that can result in phytotoxic damage to the fruit stored in the storage area. The airflow is maintained at a constant rate of 0.5 metres per second, to move the antimicrobial vapour out of the dispersal unit 10 and into the storage area, as has been described.

In this preferred embodiment, the surface area, cartridge depth, air flow rate and heater temperature act in synergy to maintain the antimicrobial vapour at an optimum concentration over the dispersal period. Maintaining a constant temperature and airflow rate means that, while the dispersal rate is initially relatively high, as the antimicrobial active material is desorbed and vapourised from the microporous solid, the concentration of antimicrobial active material in the formulation 14 decreases, and hence the dispersal rate decreases over the course of a treatment period.

In this way, the dispersal rate is relatively high in the early stages of the treatment, when a high dispersal rate is required to disperse the antimicrobial vapour relatively quickly into the air of the storage area, thereby providing optimum protection for the stored goods in a relatively short space of time. The dispersal rate decreases gradually so that in later stages, when it is necessary only to maintain the concentration of antimicrobial vapour in the storage area, the rate is relatively low. The antimicrobial vapour is therefore dispersed such that the concentration of antimicrobial vapour is high enough to reduce rotting of the fruit, but low enough to avoid any unwanted detrimental effects such as over-exposure to the antimicrobial active material.

In one example, strawberries treated for approximately six hours with the dispersal unit 10 as described above displayed a significantly reduced incidence of rotting compared to untreated strawberries. Furthermore, there were no detrimental effects to the sensory attributes of the fruit (e.g. their taste or smell), which might result from tainting caused by the antimicrobial active material.

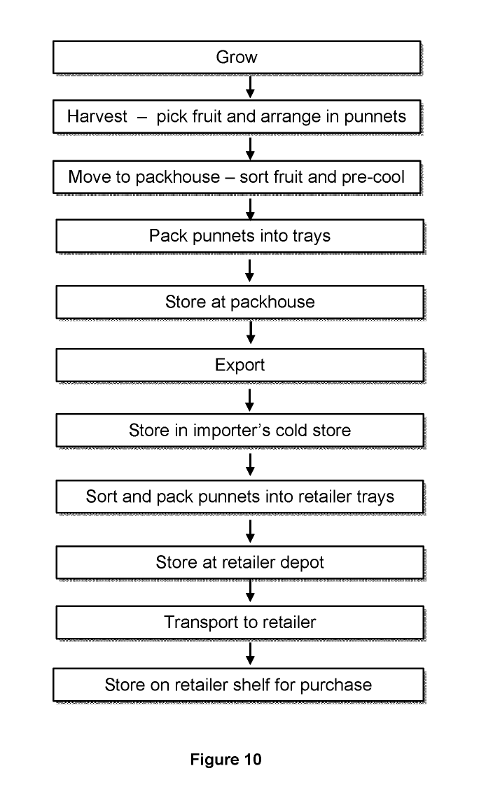

It will be appreciated that perishable goods can be treated at any suitable stage in the field-to-shelf supply chain, or at multiple stages if appropriate. FIG. 10 illustrates a typical supply chain for soft fruit such as strawberries.

Typically, the fruit is harvested and typically placed in open punnets in field crates. The field crates are transferred to a packhouse where field heat is taken out of the fruit prior to sorting and packing the punnets into cardboard cartons.

At this stage the fruit may be exported. In this case, on arrival at the importers premises, the fruit is typically placed in a cold storage facility until required for distribution. Typically, the fruit is checked for any signs of damage, including rots, prior to lidding the punnets. The lidded punnets are typically packed in plastic crates or cardboard trays before distributing to retail distribution centres. Alternatively, the export stage may be omitted, and the fruit may be checked and lidded at the packhouse, and transferred from the packhouse to retail distribution centres.

The fruit is stored temporarily at the retail distribution centres, and shipped to stores. At this stage the fruit is arranged on the shop shelves for purchase by the end customer.

It will be appreciated that the fruit can spend a considerable time in storage in the course of the supply chain. It will also be appreciated that each storage stage is optional, and may be omitted. For example, the fruit need not be stored immediately after harvesting, but may be shipped immediately to the packhouse. Similarly, the fruit need not be stored between packing and shipping to the depot, but may be shipped directly to the depot instead.

The treatment described in this specification may be applied to the fruit at any of these storage stages. Alternatively, the treatment may be applied during the process of transportation, either during export of the fruit or during transport at other stages in the supply chain, for example to the packhouse or depot. In this way, the treatment described is sufficiently versatile to accommodate different storage periods at different stages in the supply chain.

The inventors have found that it is particularly advantageous to apply the treatment immediately prior to the packing stage. Typically, the packing stage occurs early enough in the supply chain that the fruit has not yet been significantly contaminated by mould, but late enough that only a short period of time will elapse between the treatment and the fruit reaching the end customer, thereby maximising the benefit to the end customer, and prolonging the post-purchase life of the fruit as much as possible.

In alternative embodiments of the dispersal unit 10, each cartridge 12 may be provided as a pad or substrate constructed from cellulose fibres. The substrate is soaked in a formulation that comprises an antimicrobial active material and a solvent.

In this way, the cellulose fibres form the microporous solid that supports the formulation. When the substrates are heated by the heater 52, the antimicrobial active material is desorbed from the cellulose fibres and vapourised to produce the antimicrobial vapour.

In this alternative embodiment, the pad may be packaged in a foil covering or pouch. The pouch comprises major walls that cover upper and lower faces of the pad. At least one of the walls comprises an aperture that is covered by a removable closure, such as an adhesive sheet, for storage purposes.

When the cartridge is arranged in the dispersal unit for use, the removable closure is removed, such that the pad is exposed to the surrounding atmosphere via the aperture. The cartridge is arranged in the dispersal unit with a base defined by one of the major sides facing downwardly, in contact with the hotplate, and the now-open aperture arranged upwards, adjacent the airflow passage. In this way, the hotplate heats the base of the cartridge, which transfers heat to the formulation by conduction. The antimicrobial vapour is vapourised from the formulation and released into the airflow passage through the open aperture.

In this way, the removable closure can be removed from the cartridge, and the formulation can be exposed for vapourisation, without the need for the user to come into contact with the formulation. This facilitates handling of the cartridge, avoiding the need for protective clothing and minimising the input time required by the user in setting up the treatment process.

The rate of dispersal of the antimicrobial active material and the dispersal period may be varied by varying the fibre density of the sheet. A higher density of fibres means that a larger quantity of the formulation can be contained in the cartridge. For example, the density of the sheet may be between approximately 700 g per square metre and 1500 g per square metre. The dispersal rate and period may additionally or alternatively be varied by varying the thickness of the sheet, which may be for example between approximately 2 mm and approximately 5 mm.

Use of the substrate described is particularly advantageous. The substrate is of uniform thickness, and hence provides a uniform depth of formulation, which improves control of the dispersal rate. Supporting the antimicrobial active material on a substrate, rather than on, for example, a zeolite, also provides a higher dispersal rate, as the antimicrobial active material is more easily desorbed.

In particularly preferred embodiments of any of the forms of cartridge 12 and formulation 14 described, the solvent used in the formulation 14 is propylene glycol. It has been found that propylene glycol is particularly effective when employed as a solvent as it is a non-toxic, food-grade solvent, and is of relatively low flammability compared to other solvents such as ethanol and hexane. The low flammability of propylene glycol means that the formulation 14 is easier to process and to pack.

Additionally, propylene glycol does not undergo significant vapourisation at operating temperatures of 40° C., meaning that operators of the dispersal unit 10, and personnel working in the storage area during or after the dispersal period, will not be exposed to vapourised solvent.

It should be appreciated that various modifications and improvements can be made without departing from the scope of the invention as defined in the appended claims. For example, the formulation need not necessarily be provided in a cartridge 12, but may instead be placed directly into the dispersal unit 10. In this case a tray or similar structure may be provided above the heater 52 to receive the formulation 14.

The cartridge 12 and/or the dispersal unit 10 may be of any shape and need not be rectangular. The dispersal unit 10 may also be arranged to hold any number of cartridges 12. The chassis 18, runners 34, handles 32 and cover 20 of the dispersal unit 10 may be made from any suitable material, for example stainless steel, and may be coated or painted as desired.

The runners 34 of the dispersal unit 10 may be omitted, or may be replaced with alternative constructions. For example, the base 22 of the dispersal unit 10 may be provided with a plurality of feet that hold the dispersal unit 10 above a floor of the storage area, to promote airflow around the dispersal unit 10.

Although in the embodiments described, the cartridges 12 are placed on top of the heater 52 and the cover 20 is placed on top of the cartridges 12, these components may be arranged in any manner that allows the heater 52 to heat the cartridges 12, and allows vapour of the antimicrobial active material to be drawn from the cartridges 12 into the airflow passage. For example, the cover 20 may be provided at the base of the chassis 18, the cartridge 12 may be arranged above the cover 20, and the heater 52 may be arranged above the cartridge 12. In this case, the cover 20 may be integrated with the chassis 18, such that it forms the base of the tray region 30 of the chassis 18.

In the embodiments described, the antimicrobial active material is vapourised by heating the formulation. However, it should be appreciated that the antimicrobial active material may be vapourised by any suitable means, for example by ultrasonics. It should also be appreciated that some vapourisation of the antimicrobial active material may occur even without heating the formulation, thus the terms ‘vapourise’ or ‘vapourising’ also include allowing the antimicrobial active material to vapourise, for example by removing the lid from the cartridge, or the outer bag from the sachet.

In the embodiments described, the airflow passes over the formulation. However, the airflow may alternatively pass through the formulation. In a further alternative embodiment of the invention, the airflow may be heated instead of, or in addition to, the formulation.

### EXAMPLES

### Example 1

An antimicrobial formulation was prepared by dissolving thymol in ethanol, and mixing the solution with a zeolite. The ratio of thymol:ethanol:zeolite was 3:2:15, by mass. The formulation was packed into sachets made from a natural fibrous material, and four sachets were inserted into a dispersal unit for use in treating post-harvest fruit.

To demonstrate the efficacy of the treatment, a series of trials were carried out on soft fruit in the form of strawberries. Treatments were carried out at different stages of the supply chain, as will be described

To treat the fruit, the strawberries were loosely packed in open punnets, and the punnets were arranged in crates. The crates were arranged in a storage container on pallets. The storage container was an enclosed, refrigerated, static container in the form of a refrigerated truck trailer, a refrigerated sea container or a cold storage container. A dispersal unit containing four sachet cartridges was arranged under one of the pallets in the storage container. The dispersal unit was activated to treat the strawberries, and the treatment was carried out with the following parameters:

### Typical Storage Container Parameters:

Storage container volume: approximately 28 m³
Storage container temperature: 3° C.

### Formulation Parameters:

Antimicrobial active material: thymol
Solvent: ethanol
Microporous solid: zeolite
Ratio by mass of thymol:ethanol:zeolite: 3:2:15

### Dispersal Unit Parameters:

Hot plate temperature: 40° C.
Air flow rate: 0.5 metres per second
Treatment time: 6 hours

The fruit was treated and transferred to shelf-life conditions (i.e. storage at a temperature of between 6° C. and 8° C.) for a period of 4-5 days, in line with the retailer use-by date specifications. After this period, the incidence of rot on the treated strawberries was compared with the incidence of rot on a control sample of untreated strawberries stored at the same conditions.

FIGS. 10a and 10b illustrate exemplary comparative samples of treated and untreated strawberries after storage for 4-5 days at a temperature of between 6° C. and 8° C. The untreated strawberries, shown in FIG. 10a, show significant rotting, while the treated strawberries, shown in FIG. 10b, shows no visible signs of rotting.

In the study, fruit was treated at various stages in the supply chain with the following results:

i) Fruit grown in the UK, and treated in the UK during a storage period after picking and prior to packing:

Percentage reduction in rots -
arranged by strawberry variety

| Source country | Elsanta | Finesse | Portola | Albian |
|---|---|---|---|---|
| UK | 85.5 | | | |
| UK | 93 | | | |
| UK | 90 | | | |
| UK | 96 | | | |
| UK | | 33 | | |
| UK | | 36 | | |
| UK | | | 79 | |
| UK | 72 | | | |
| UK | 43 | | | |
| UK | 43 | | | |
| UK | 74 | | | |
| UK | | | | 42 |
| UK | 64 | | | |
| UK | | 36 | | |
| UK | 77 | | | |
| UK | 92 | | | |

ii) Fruit grown abroad, imported to the UK, and treated during a storage period after importing and prior to packing:

| | Percentage reduction in rots - | | |
|---|---|---|---|
| | arranged by strawberry variety | | |
| Source country | Elsanta | Festival | Sabrosa |
| Holland | 83 | | |
| Holland | 100 | | |
| Holland | 87.3 | | |
| Holland | 90.9 | | |
| Holland | 80 | | |
| Holland | 75.6 | | |
| Holland | 87 | | |
| Egypt | | 73.3 | |
| Egypt | | 93.6 | |
| Egypt | | 52.4 | |
| Egypt | | 47 | |
| Spain | | 72 | |
| Spain | | | 53 |
| Spain | | | 69 |
| Spain | | | 31 |
| Spain | | | 36.6 |
| Spain | | | 70.8 |
| Spain | | | 62 |
| Spain | | | 68.9 |

iii) Fruit grown abroad and treated abroad during a storage period after picking and prior to importing:

Percentage reduction in rots -
arranged by strawberry variety

| Source country | Sabrosa | Splendor |
|---|---|---|
| Spain | 38.4 | |
| Spain | 38.4 | |
| Spain | 30.8 | |
| Spain | 64.1 | |
| Spain | 78 | |
| Spain | 70.5 | |
| Spain | 78.5 | |
| Spain | 66.7 | |
| Jordan | | 64 |
| Jordan | | 58 |
| Jordan | | 53 |
| Jordan | | 61 |
| Jordan | | 53 |

The above data illustrates a clear reduction in the incidence of rots, with treated fruit demonstrating between a 30% and 100% reduction in the incidence of rotting. The average reduction in the incidence of rotting across the full study was 65%.

### Example 2

To determine the effect of temperature on the release rate of the antimicrobial active material, treatments were conducted at a variety of operating temperatures, and the mass loss was monitored at hourly intervals over a six-hour treatment period.

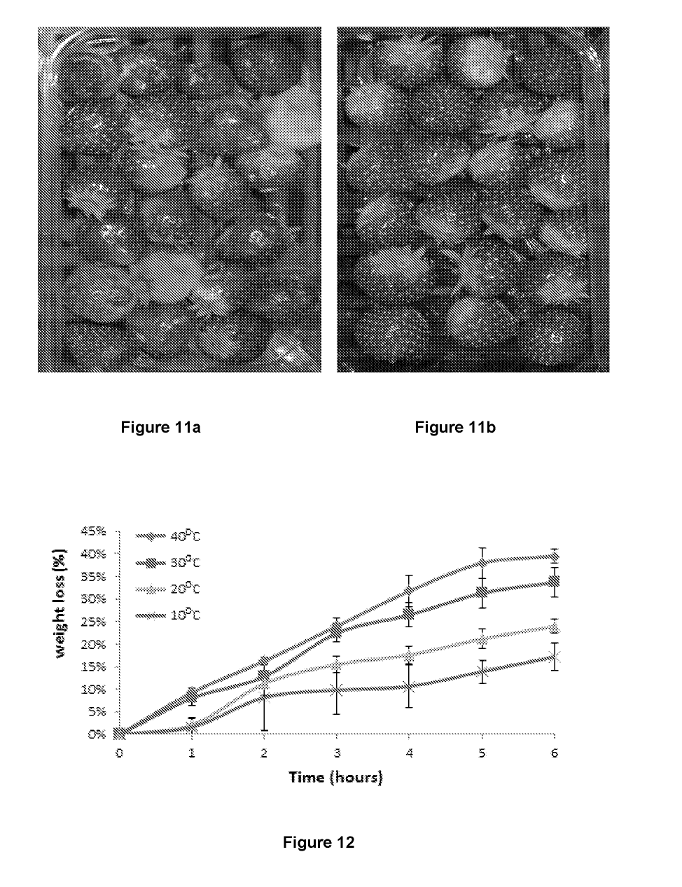

A formulation was prepared and treatment was carried out in accordance with Example 1. The initial mass of each cartridge was measured, and the mass was subsequently measured hourly over the treatment period. A graph illustrating the measured mass reduction for treatments carried out with a hot plate at 10° C., 20° C., 30° C. and 40° C. is shown in FIG. 11.

The power consumption of the dispersal unit was measured for a variety of hotplate temperatures, at as is shown below. As reasonably expected, a higher operating temperature consumes a larger amount of energy.

| | Operating | Energy consumed |
|---|---|---|
| | temperature | during treatment |
| Unit | (° C.) | (kWh) |
| 1 | 40 | 0.4 |
| 2 | 30 | 0.3 |
| 3 | 20 | 0.2 |
| 4 | 10 | 0.2 |

It will be appreciated that the mass reduction is not entirely attributable to loss of the antimicrobial active ingredient. The solvent is more easily vapourised, and so during the treatment process the majority of the solvent is removed from the formulation. By contrast, only a small proportion of the antimicrobial active material is removed. Samples of the formulation analysed before and after completion of the six-hour treatment indicated that, for the treatment conducted at 40° C., only 2.24° A) of the antimicrobial active material is released from the formulation. Thus, even at relatively high temperatures of 40° C., only a small proportion of the antimicrobial active material is removed from the formulation.

Treatments were also conducted at hot-plate temperatures of greater than 40° C. At these temperatures, the fruit demonstrated signs of phytotoxic damage.

### Example 3

To determine release rates of the antimicrobial active material from the cartridge, tests were carried out on different types of cartridge containing formulations comprising thymol dissolved in different solvents. Tests were conducted on formulations including i) ethanol, ii) ethylene glycol and iii) propylene glycol (propan-1,2-diol), and for each type of solvent in i) sachet cartridges containing a formulation comprising thymol, solvent and zeolite and ii) pad-style cartridges in which a thymol-solvent mixture was supported on a cellulose fibre sheet.

To test the release rate, the cartridges were heated on hot plates held at a temperature of 40° C. for a test period of six hours. The initial mass of the cartridge was recorded, and the decrease in mass over the test period was monitored at hourly intervals.

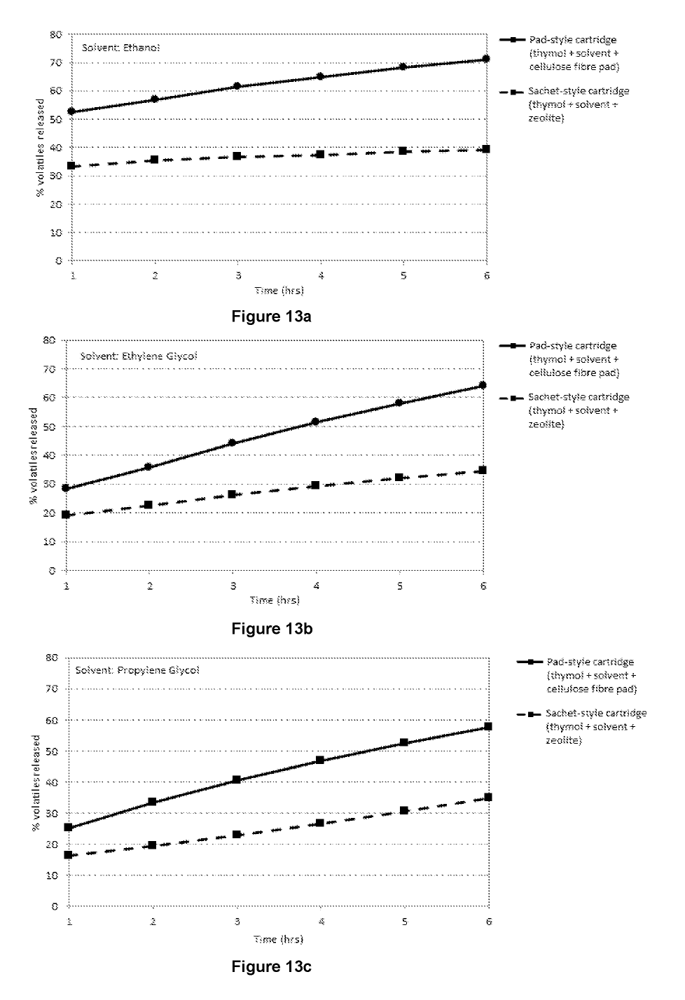

The results, shown in FIG. 13, illustrate that the thymol is released more quickly from the pad-style cartridge than from the sachet style cartridge. After a typical six-hour treatment period, less than 40% of the antimicrobial active material had been released from the sachet, while in the same time period approximately 60% or more of the antimicrobial active material had been released from the pad.

The results also illustrate the release rate is faster when ethanol is used as the solvent in the formulation. For both the pad and the sachet, the release rate drops when ethylene glycol is used and drops further when propylene glycol is used.

### Example 4

To monitor the effect of cartridge mass and depth on the release of the antimicrobial active material from the cartridge, tests were carried out using sachet-style cartridges of a variety of masses. Cartridges of the same cross-section (an 18 cm by 13 cm rectangle, with an area of 0.0234 m²), were filled with varying masses of the formulation described above with regard to Example 1, such that the mass of the cartridge was directly proportional to its thickness.

Tests were carried out using cartridges containing 125 g, 150 g, 175 g, 200 g and 250 g of formulation, and using hotplates at 10° C., 20° C., 30° C. and 40° C. Each treatment was carried out for 6 hours in total. The total mass of the cartridge was measured before and after the treatment, and the mass lost during the treatment processes were as follows:

| | Amount of material vaporised (g), by cartridge mass | | | | |
|---|---|---|---|---|---|
| Temperature (° C.) | 250 g | 200 g | 175 g | 150 g | 125 g |
| 10 | 10.7 | — | — | — | 14.1 |
| 20 | 15 | — | — | — | 19.5 |
| 30 | 21 | — | — | — | 21 |
| 40 | 24.7 | 24 | 23.5 | 22 | 23 |

The results indicate that the thickness of the cartridge has a significant impact on the amount of material released in the six-hour treatment period.

At lower hot plate temperatures (10° C. or 20° C.) a greater amount of material is vapourised from cartridges having a lower mass, i.e. from thinner cartridges. This is thought to result from the fact that material is vapourised from the upper surface of the formulation, while the hot plate is in contact with the lower surface of the formulation. A temperature gradient will inevitably exist across the thickness of the cartridge; hence, the thicker the cartridge, the lower the temperature at the upper surface of the formulation, and the lower the release rate.

At higher hot plate temperatures (40° C.) the relationship is more complex. At high thicknesses (e.g. cartridges having 250 g of material), the amount of material released is relatively high. As thickness decreases, the amount of material released also decreases initially. However, as the thickness decreases further, the amount of material released from the cartridge increases once more. This is thought to result from the fact that the temperature gradient will be less significant for higher hot plate temperatures.

1. A dispersal unit for use in treating perishable goods in a storage volume to control microbial growth, the dispersal unit comprising:
a housing;
an airflow passage in the housing;
an impeller for driving a flow of air through the airflow passage;
a support for supporting at least one replaceable cartridge in communication with the airflow passage; and
a vapouriser for promoting vapourisation of a volatile antimicrobial active material in a cartridge supported by the support to release an antimicrobial vapour from the cartridge into the airflow passage to be entrained in the flow of air and expelled from the airflow passage into the storage volume;
wherein the support is a base wall of a shallow vapourisation chamber that incorporates the airflow passage between the base wall and an upper wall spaced from the base wall and has openings between the base wall and the upper wall defining an inlet and an outlet of the vapourisation chamber; and
the height of the vapourisation chamber between the base wall and the upper wall is less than 40% of a width or length of the base wall.

2. The dispersal unit of claim 1, wherein the support is arranged to support a plurality of cartridges.

3. The dispersal unit of claim 2, wherein the support is elongate in an airflow direction through the unit such that the cartridges may be disposed in succession in the airflow direction.

4. The dispersal unit of claim 1, wherein the vapourisation chamber is elongate between an inlet at one end and an outlet at an opposite end.

5. (canceled)

6. The dispersal unit of claim 1, wherein the upper wall is a wall of the housing.

7. The dispersal unit of claim 1, wherein the upper wall can be lifted away from the support to replace the cartridge.

8. The dispersal unit of claim 1, wherein the support is a hotplate that serves as the vapouriser.

9. The dispersal unit of claim 1, wherein the support is arranged to receive the cartridge, for example in a recess.

10. (canceled)

11. The dispersal unit of claim 10, wherein the dispersal unit is dimensioned so as to fit under or within a storage pallet and has a height less than 40% of its width.

12. (canceled)

13. In combination, the dispersal unit of claim 1, when fitted with at least one cartridge between the support and the upper wall of the vapourisation chamber.

14. The combination of claim 13, wherein the airflow passage is between the cartridge and the upper wall of the vapourisation chamber.

15. The combination of claim 13, wherein the cartridge defines a first major face with at least one opening communicating with the volatile antimicrobial active material and is supported in the unit with its first major face exposed to the airflow passage.

16. The combination of claim 15, wherein the cartridge defines a second major face and is supported in the unit with its second major face lying against the support.

17. (canceled)

18. A method of treating perishable goods to control microbial growth, the method comprising:
placing a dispersal unit according to claim 1 into a storage volume, the dispersal unit supporting a cartridge having a volatile antimicrobial active material;
vapourising the volatile antimicrobial active material to produce an antimicrobial vapour, such that the antimicrobial vapour is entrained in an airflow in an airflow passage of the dispersal unit; and
expelling the antimicrobial vapour from the airflow passage into the storage volume.

19. The method of claim 18, comprising inserting the cartridge into the dispersal unit.

20. (canceled)

21. The method of claim 18, comprising inserting a plurality of cartridges into the dispersal unit such that the cartridges are disposed in succession in an airflow direction in the dispersal unit.

22. (canceled)

23. The method of claim 18, comprising removing or replacing the cartridge after a dispersal period.

24. The method of claim 23, comprising lifting an upper wall of a vapourisation chamber of the dispersal unit away from a support that supports the cartridge to remove or replace the cartridge.

25. The method of claim 18, further comprising arranging the perishable goods in the storage volume on at least one pallet, and placing the dispersal unit under the pallet.

26. The method of claim 18, further comprising vapourising the volatile antimicrobial active material by heating.

27. The method claim 18, wherein the method is carried out during storage or transportation of the perishable goods.

28-50. (canceled)
